(19) United States
(12) Patent Application Publication
(10) Pub. No.: US 2018/0016196 A1
(43) Pub. Date: Jan. 18, 2018

(54) FOOD WASTE FERMENTATION DEVICE USING SOIL MICROBES AND LIVESTOCK MANURE COMPOSTING DEVICE, BIOFIELD GENERATOR SUITABLE FOR SAME, MICROBIAL CELL SUITABLE FOR SAME AND MICROBIAL CONDENSER SUITABLE

(71) Applicant: TSNT GLOBAL CO., LTD, Nam-gu Daegu (KR)

(72) Inventor: KYOO HWAN CHOI, Gyeonggi-do (KR)

(21) Appl. No.: 15/548,022

(22) PCT Filed: Feb. 2, 2016
(86) PCT No.: PCT/KR2016/001145

§ 371 Date: Aug. 1, 2017

(30) Foreign Application Priority Data
Feb. 12, 2015 (KR) 10-2015-0021457
Feb. 1, 2016 (KR) 10-2016-0012281

(51) Int. Cl. C05F 17/00; C05F 17/02; C05F 9/02; C05F 3/06; C05C 9/00; B09B 3/00; H01M 8/16; A01C 3/02

(52) U.S. Cl. CPC C05F 17/0081; H01M 8/16; C05F 17/0258; C05F 17/0036; A01C 3/023; C05F 3/06; C05C 9/00; B09B 3/00; C05F 9/02

(57) ABSTRACT

Disclosed are a food waste fermentation device and a livestock manure composing device both using soil microbes, and a biofield generator, a microbial cell, and a microbial condenser all of which are suitably used for the devices. The food waste fermentation device includes: a food waste treatment tank for containing food waste; and a biofield generator for promoting lactic acid fermentation of food waste. The biofield generator includes a DC module or an AC module. The DC module includes a DC battery, a frequency generator generating a predetermined frequency carrier wave using DC power, a microbial cell electrically connected to the frequency generator, and a DC output portion. The DC module generates a biofield consisting of an electromagnetic field generated by the frequency generator and an electromagnetic field generated by the microbial cell. The AC module generates a biofield using an AC input signal and a microbial condenser.

### TECHNICAL FIELD

The present invention relates to a food waste fermentation device and a livestock manure composting device both using soil microbes, wherein both devices use a weak electric field generated by soil microbes, a biofield generator suitably used for the devices, a microbial cell suitably used for the devices, and a microbial condenser suitably used for the devices.

### BACKGROUND ART

A huge amount of food waste is discarded from individual households or public buildings, and it is a serious problem in terms of national economy and environmental pollution.

Although there have been campaigns and education programs to resolve this worrying problem, generation of a large amount of food waste still remains a social problem.

Accordingly, study has been extensively conducted to exploit advantages of recycling of food waste, for example, improvement in economy and environment. As one of the recycling methods, a method of drying food waste and then processing the dried food waste into fertilizer or livestock feed has drawn attention.

Typically a conventional fermentation drier for recycling food waste as fertilizer or feed is equipped with a fermentation and drying chamber, a mixer, a hot air generator, a hot air sprayer, etc.

The fermentation and drying chamber includes a hopper, through which food waste is introduced, at an upper end thereof, and an air supply port and an air exhaust port provided at a lower end thereof.

The mixer includes a rotary shaft that is installed near the bottom in the fermentation and drying chamber and which horizontally extends in a horizontal direction (a left and right direction) and ribbon-shaped mixing blades attached to the to rotary shaft via arms and symmetrically arranged at a left side and a right side of the rotary shaft so that food waste can gather at a middle portion of the rotary shaft. The mixer mixes food waste in the fermentation and drying chamber.

The hot air generator supplies hot air to an upper portion of the fermentation and drying chamber.

The hot air sprayer is installed in the fermentation and drying chamber, extends in parallel with the rotary shaft between the hot air exhaust port and the mixer, and has spray nozzles that are open downward. The hot air sprayer sprays hot air generated by the hot air generator to food waste.

However, the conventional fermentation drier is structured such that it is difficult to maintain the internal temperature thereof. Since a uniform temperature cannot be maintained in the conventional fermentation drier, there is a problem that food waste is not readily decomposed by microbes.

In addition, since the conventional fermentation drier is not equipped with a deodorizing device, feed or fertilizer produced through processing of waste food still emits odors. Therefore, the feed or fertilizer is unsuitable for use.

### DISCLOSURE

### Technical Problem

Accordingly, the present invention has been made keeping in mind the above problems occurring in the related art, and a general object of the present invention is to provide a food waste fermentation device and a livestock manure composting device both using soil microbes to substantially address various problems attributable to limitations and disadvantages of conventional technologies.

A specific object of the present invention is to provide a food waste fermentation device using soil microbes, the device being capable of fermenting food waste by promoting lactic acid fermentation, whereby the device causes fermentation of food waste rather than putrefaction of food waste, thereby removing the bad odor of food waste.

Another specific object of the present invention is to provide a livestock manure composting device using soil microbes, the device being capable of reducing the bad odor of livestock manure fertilizer and improving compost maturity.

A further specific object of the present invention is to provide a biofield generator suitably used for the food waste fermentation device and the livestock manure composing device.

A yet further specific object of the present invention is to provide a microbial cell suitably used the food waste fermentation device and the livestock manure composting device.

A yet further specific object of the present invention is to provide a microbial condenser suitably used for the food waste fermentation device and the livestock manure composting device.

### Technical Solution

In order to accomplish the above object, according to one aspect, the present invention provides a food waste fermentation device.

The food waste fermentation device for fermenting food waste includes:

a food waste treatment tank for containing food waste; and

a biofield generator electrically connected to the food waste treatment tank and promoting lactic acid fermentation of the food waste,

the biofield generator including either a DC module or an AC module,

the DC module including a DC battery, a frequency generator receiving direct current (DC) power from the DC battery and generating a predetermined frequency carrier wave, and a microbial cell and a DC output portion electrically connected to the frequency generator, the DC module generating a biofield consisting of an electromagnetic field generated by the frequency generator and an electromagnetic field generated by the microbial cell,

the AC module including an AC input portion, a microbial condenser electrically connected to the AC input portion, and an AC output portion electrically connected to the microbial condenser, the AC module generating a bioelectric field consisting of an electromagnetic field generated using an AC input signal and an electromagnetic field generated by the microbial condenser.

The biofield generator may further include a light emitting device (LED) display lamp that is electrically connected between the frequency generator and the DC output portion and flashes in accordance with operation of the frequency generator.

The microbial cell may further include:

two plastic vessels for containing soil dough mixed with soil microbes including lactobacillus performing lactic acid fermentation of food waste;

a negative electrode and a positive electrode respectively installed in the soil dough contained in the two plastic vessels;

a conductive wire connecting the two plastic vessels to each other such that electrons generated from the negative electrode move to the positive electrode via the conductive wire; and

ventilation holes provided to the two plastic vessels to enable the soil microbes in the soil dough to perform aerobic respiration.

The soil dough may be prepared by mixing a soil mixture and salt water with a mixing ratio of 4:1 in terms of weight, the soil mixture being prepared by mixing sterilized soil and cultured soil microbes including lactobacillus with a mixing ratio of 5:1 in terms of weight.

The sterilized soil may contain a far-infrared radiation substance.

The microbial condenser may use dried soil dough mixed with soil microbes, provided between two metal plates, as a dielectric.

The soil dough may be prepared by mixing a soil mixture and salt water mixed with a mixing ratio of 4:1 in terms of weight, the soil mixture being prepared by mixing sterilized soil and cultured soil microbes including lactobacillus with a mixing ratio of 5:1 in terms of weight.

The sterilized soil may contain a far-infrared radiation substance.

In order to accomplish another object of the present invention, there is provided a livestock manure composing device.

The livestock manure composing device includes:

a livestock manure fermentation tank for containing and fermenting livestock manure; and

a biofield generator electrically connected to the livestock manure fermentation tank and promoting a urea production reaction of ammonia generated from livestock manure,

the biofield generator including a DC module or an AC module,

the DC module including a DC battery, a frequency generator receiving direct current power from the DC battery and generating a predetermined frequency carrier wave, and a microbial cell and a DC output portion electrically connected to the frequency generator, the DC module generating a biofield consisting of an electromagnetic field generated by the frequency generator and an electromagnetic field generated by the microbial cell,

the AC module including an AC input portion, a microbial condenser electrically connected to the AC input portion, and an AC output portion electrically connected to the microbial condenser, the AC module generating a biofield consisting of an electromagnetic field generated using an AC input signal and an electromagnetic field generated by the microbial condenser.

The microbial cell may include:

two plastic vessels for containing soil dough mixed with soil microbes including

an effective microorganism (EM) for urine synthesis from livestock;

a negative electrode and a positive electrode respectively installed in the soil dough contained in the two plastic vessels;

a conductive wire connecting the two plastic vessels to each other such that electrons generated from the negative electrode move to the positive electrode; and

ventilation holes provided to the two plastic vessels to enable the soil microbes in the soil dough contained in the two plastic vessels to perform aerobic respiration.

The soil dough may be prepared by mixing a soil mixture and salt water with a mixing ratio of 4:1 in terms of weight, the soil mixture being prepared by mixing sterilized soil and soil microbes including an effective microorganism with a mixing ratio of 5:1 in terms of weight.

The sterilized soil may contain a far-infrared radiation substance.

The microbial condenser may use dried soil dough mixed with soil microbes, provided between two metal plates, as a dielectric.

The soil dough may be prepared by

mixing a soil mixture and salt water with a mixing ratio of 4:1 in terms of weight and then dried to have a water content of 10% or less, the soil mixture being prepared by mixing sterilized soil and soil microbes including an effective microorganism with a mixing ratio of 5:1 in terms of weight.

The sterilized soil may contain a far-infrared radiation substance.

In order to accomplish the further object of the present invention, there is provided a biofield generator for generating a biofield.

The biofield generator includes:

a frequency generator generating a predetermined frequency carrier wave; and

a microbial cell electrically connected to the frequency generator,

in which an output terminal of the microbial cell outputs a biofield consisting of an electromagnetic field generated by the frequency generator and an electromagnetic field generated by the microbial cell.

The microbial cell may include:

two plastic vessels for containing soil dough mixed with soil microbes;

a negative electrode and a positive electrode respectively installed in the soil dough in the two plastic vessels;

a conductive wire connecting the two plastic vessels to each other such that electrons generated from the negative electrode move to the positive electrode; and

ventilation holes provided to the two plastic vessels to enable the soil microbes in the soil dough contained in the two plastic vessels to perform aerobic respiration.

The soil dough may be prepared by mixing a soil mixture and 3% salt water with a mixing ratio of 4:1 in terms of weight, the soil dough being prepared by mixing soil that is sterilized at a temperature of 80 to 100° C. for three hours and cultured soil microbes with a mixing ratio of 5:1 in terms of weight.

The sterilized soil may be soil containing a far-infrared radiation substance.

The biofield generator may further include an LED display lamp that is electrically connected to the frequency generator and which flashes in accordance with operation of the frequency generator.

In order to accomplish the yet further object of the present invention, there is provided a biofield generator

generating a biofield, the biofield generator including:

an AC input portion; and

a microbial condenser electrically connected to the AC input portion.

The microbial condenser uses soil dough mixed with soil microbes, provided between two metal plates, as a dielectric.

When an AC input signal supplied through the AC input portion is applied between the two metal plates, the biofield generator generates a biofield consisting of an electromagnetic field generated between the two metal plates applied with the AC input signal and an electromagnetic field generated by the microbial condenser.

The soil dough may be prepared by mixing a soil mixture and 3% salt water with a mixing ratio of 5:1 in terms of weight and dried to have a water content of 10% or less, the soil mixture being prepared by mixing soil sterilized at a temperature of 80 to 100° C. for three hours and cultured soil microbes with a mixing ratio of 5:1 in terms of weight.

The sterilized soil may be soil containing a far-infrared radiation substance.

In order to accomplish the yet further object of the present invention, there is a microbial cell including:

two plastic vessels for containing soil dough mixed with soil microbes;

a negative electrode and a positive electrode respectively installed in the soil dough contained in the two plastic vessels;

a conductive wire connecting the two plastic vessels to each other such that electrons generated from the negative electrode move to the positive electrode; and

ventilation holes provided to the two plastic vessels to enable the soil microbes contained in the soil dough to perform aerobic respiration.

The soil dough may be prepared by mixing a soil mixture and 3% salt water with a mixing ratio of 4:1 in terms of weight, the soil mixture being prepared by mixing soil sterilized at a temperature of 80 to 100° C. for three hours and cultured soil microbes with a mixing ratio of 5:1 in terms of weight.

The sterilized soil may contain a far-infrared radiation substance.

In order to accomplish the yet further object of the present invention, there is provided a microbial condenser

having a dielectric provided between two metal plates,

the dielectric being dried soil dough mixed with soil microbes, the microbial condenser outputting a biofield generated by the soil microbes between the two metal plates.

The soil dough may be prepared by mixing a soil mixture and 3% salt water with a mixing ratio of 4:1 in terms of weight and dried to have a water content of 10% or less, the soil mixture being prepared by mixing soil sterilized at a temperature of 80 to 100° C. for three hours and cultured soil microbes with a mixing ratio of 5:1 in terms of weight.

### Advantageous Effects

The food waste fermentation device using soil microbes, according to the present invention, can solve a problem of bad odor by promoting lactic acid fermentation of food waste rather than putrefaction of food waste.

In addition, the livestock manure composing device using soil microbes, according to the present invention, has an advantage of reducing bad odor and increasing a fertilizer effect of produced fertilizer because the biofield performs a catalytic action in a urea production reaction of ammonia generated from livestock manure.

In addition, the biofield generator according to the present invention can be applied to various fields such as a composting process of organic wastes such as agro-fishery byproducts, slaughter plant byproducts, and food processing byproducts, a food storage system, a plant growth promoting device, etc. as well as to the food waste fermentation device and the livestock manure composing device, thereby having effects of reducing bad odor, maintaining freshness of food, promoting growth, etc.

### DESCRIPTION OF DRAWINGS

FIG. 1 is a circuitry diagram illustrating the construction of a biofield generator using soil microbes, according to one embodiment of the present invention;

FIG. 2(a) is a front view and FIG. 2(b) is a rear view of pictures showing the construction of the biofield generator using soil microbes, according to one embodiment of the present invention;

FIG. 3 is a circuitry diagram illustrating the construction of a microbial cell according to one embodiment of the present invention;

FIGS. 4 and 5 are pictures of the microbial cell;

FIGS. 6 and 7 are diagrams illustrating the construction of a microbial condenser according to one embodiment of the present invention;

FIG. 8 is a schematic block diagram of a food waste fermentation device according to one embodiment of the present invention;

FIG. 9 is pictures illustrating the results of a decomposition test of food waste that is treated by a biofield and a decomposition test of food waste that is untreated by a biofield;

FIG. 10 is a schematic block diagram illustrating the construction of a livestock manure composing device according to one embodiment of the present invention;

FIG. 11 is a picture of a livestock manure mixing tank (fermentation tank) in which a biofield generator according to one embodiment of the present invention is installed;

FIG. 12 illustrate the results of a compost maturity test; and

FIGS. 13 and 14 are pictures illustrating test results of growth promotion of an object that is treated by a biofield generator according to one embodiment of the present invention and a material that is untreated by the biofield generator.

### BEST MODE

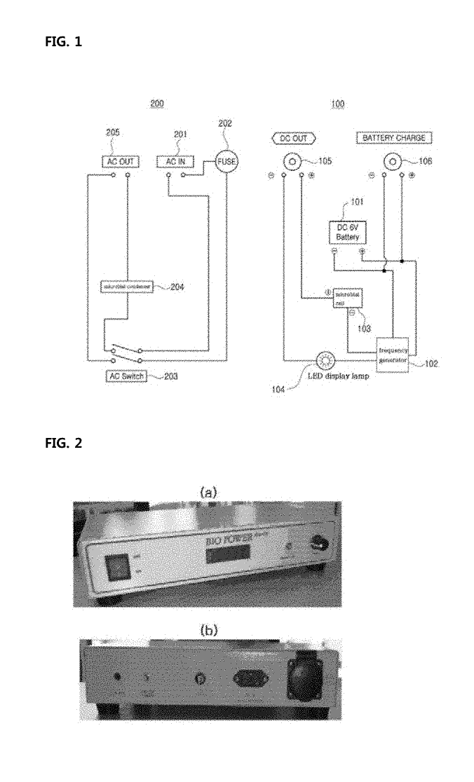

FIGS. 1 and 2 are views illustrating the construction of a biofield generator using microbes, according to one embodiment of the present invention, in which FIG. 1 is a circuitry diagram, FIG. 2(a) is a front view, and FIG. 2(b) is a rear view.

With reference to FIGS. 1 to 2, according to one embodiment of the present invention, a biofield generator 1 using microbes includes a DC module 100 or an AC module 200.

The DC module 100 generates a biofield using direct current (DC) power. The DC module 100 includes a DC battery 101, a frequency generator 102, a microbial cell 103, an LED display lamp 104, a DC output portion 105, and a battery charging unit 106.

For example, the DC battery 101 is a 6 V battery. The DC battery 101 supplies DC power to the frequency generator 102.

The frequency generator 102 generates a predetermined frequency carrier wave and supplies it to the microbial cell 103. The frequency of the carrier wave generated by the frequency generator 102 can be adjusted within a range of 8 to 1500 Hz. The frequency generator 102 adjusts the frequency in accordance with a selected microbe and finds an optical frequency for the microbe. The determined frequency affects a fermentation rate.

The microbial cell 103 is used to generate a weak electromagnetic field using soil microbes, and the microbial cell 103 is prepared using soil microbes having a desirable effect.

When the carrier wave generated by the frequency generator 102 passes through the microbial cell 103, a biofield generated due to growth of microbes is carried by the carrier wave, thereby coming out of the microbial cell 103 along with the carrier wave. The biofield generated from the microbial cell 103 acts like an emitter of an amplifier transistor.

Soil microbes contained in the microbial cell 103 emit unique biophotons coming out of the DNA thereof, thereby generating a biofield having the characteristics of the microbes. When the biofield generator 1 generates a biofield within a certain space, the characteristics of microbes are expressed in the biofield. The construction and manufacturing method of the microbial cell 103 will be described below in detail.

The LED display lamp 104 flashes in accordance with operation of the frequency generator 102. Therefore, operation of the frequency generator 102 can be checked by eye.

The DC output portion 105 is an output terminal of the DC module 100 and outputs a biofield generated using DC power.

The battery charging unit 106 charges the DC battery 101.

Meanwhile, the AC module 200 is a device to generate a biofield using AC power. The AC module 200 includes an AC input portion 201, a fuse 202, an AC switch 203, a microbial condenser 204, and an AC output portion 205.

The AC input portion 201 is a terminal electrically connected to an external AC power supply. The fuse 202 is a short circuit protection fuse. The AC switch 203 is a switch to switch on and off the AC power supply.

When an AC signal having a predetermined frequency passes through the microbial condenser 204, a biofield generated due to growth of microbes is carried by the AC signal, thereby coming out of the microbial condenser 204 along with the AC signal. The signal output from the AC output portion 205 consists of the AC signal having a frequency of 50 to 60 Hz and the biofield generated by the microbial condenser 204.

The microbial condenser 204 uses dried soil dough mixed with soil microbes as a dielectric provided between two metal plates. The microbial condenser 204 stores electric charges, passes an alternating current, and intercepts a direct current, thereby generating a biofield using AC power.

The detailed construction and manufacturing method of the microbial condenser 204 will be described below.

The AC output portion 205 is an output terminal of the AC module 200. The output portion 205 is an output terminal for outputting a biofield generated using the AC power.

### MODE FOR INVENTION

Hereinafter, preferred embodiments of the invention will be described with reference to the accompanying drawings.

In the following description of the present invention, detailed descriptions of known functions and configuration which are deemed to make the gist of the present invention obscure will be omitted. All terms used herein should be interpreted as having a meaning that is consistent with their function in the present disclosure, and thus can be interpreted differently according to users, operators, and case laws. The terms should be interpreted to be consistent with a meaning in the whole context of the present disclosure.

The biofield is a weak electromagnetic field generated around living things. The weak electromagnetic field originates in biophotons emitted from DeoxynboNucleic Acid (DNA) of living things.

Biophotons are photons of light in the ultraviolet and visible light range produced by living cells in a different manner from general bioluminescence. All living things have unique DNA and the DNA emit unique biophotons.

An energy field that is necessarily produced in the process in which elements of an inorganic matter react with each other to transform to an organic matter is a biofield.

In a process in which yeast fungus decomposes nutrients such as apple juice, flour, and sugar to produce yeast, the main components of yeast are protein, amino acid, vitamins, etc. which are mainly composed of carbon (C), hydrogen (H), oxygen (O), nitrogen (N), etc.

In a process in which yeast fungus synthesizes protein, amino acid, vitamin, etc. from C, H, O, N, etc. contained in nutrients to produce yeast,

first, in terms of chemical reactions, protein, amino acid, vitamin, etc. cannot be synthesized from C, H, O, N, etc. contained in nutrients without information of a sophisticated central control command, and

second, in terms of thermodynamics, it is necessary to lower entropy such that C, H, O, N, etc. in a chaotic state can be synthesized into protein, amino acid, vitamins, etc., and energy is used to lower entropy.

That is, information of a central control command and energy are essential in the process of producing living things. An energy field to satisfy the two essential factors is a biofield.

All living things have unique DNAs and the DNAs emit unique biophotons. The biophotons generate a unique biofield, thereby forming the characteristics of each living thing.

In the present invention, soil microbes are used in the biofield generator. The reason is based on the assumption that a biofield promoting formation of a living thing is generated by an interaction between soil and soil microbes.

Predominant three kinds of microbes present in soil include mold, actinomyces, and bacteria. Aspergillus of the mold exhibits an immuno-stimulating effect and a growth promoting effect, trichoderma exhibits an effect of breaking pathogenic bacteria, and yeast causes fermentation to produce bread and liquor.

Actinomyces includes streptomyces secreting an antibiotic substance and cellumononas decomposing amylose and cellulose. Bacteria include bacillus that produces an enzyme decomposing protein in starch and prevents damages by harmful insects, pseudomonas that decomposes an organic material, photosynthetic bacteria that promotes photosynthesis, and lactobacillus that ferments kimchi or milk and secrets bioactive substances, anticarcinogenic substances, and antibacterial substances.

Microbes in soil are essential in activity of life. Accordingly, a biofield, which is an energy field required for activity of life, is obtained from soil microbes.

The principle in which soil microbes generate a biofield will be described below.

All living things emit biophotons. The biophotons are generated from DNAs and form a weak electromagnetic field. While microbes are growing and multiplying, the microbes continuously emits weak energy waves.

In oxidation and reduction reactions that occur during the culture of soil microbes, the flow of electrons, i.e., an electric current, occurs through electron-donating and electron-accepting. When two electrodes having different ionicities are installed in cultivation vessels and the two electrodes are connected to each other via a conductive wire, a continuous electric current flows through the conductive wire due to a potential difference between the two electrodes.

This current carries a weak electromagnetic wave generated by biophotons emitted from the DNAs of microbes. The current is boosted first and then transmitted. Therefore, it is possible to reproduce a biofield, i.e. a weak electromagnetic field generated by microbes in the form of an electromagnetic wave that can be precisely adjusted. The reproduced energy field exhibits characteristics of used microbes.

FIGS. 1 and 2 are views illustrating the construction of a biofield generator using soil microbes, according to one embodiment of the present invention, in which FIG. 1 is a circuitry diagram, FIG. 2(a) is a front view, and FIG. 2(b) is a rear view.

With reference to FIGS. 1 to 2, according to the present embodiment, a biofield generator 1 using soil microbes includes a DC module 100 or an AC module 200.

The DC module 100 generates a biofield by using direct current (DC) power. The DC module 100 includes a DC battery 101, a frequency generator 102, a microbial cell 103, an LED display lamp 104, a DC output portion 105, and a battery charging unit 106.

The DC battery 101 is, for example, a 6 V battery and supplies DC power to the frequency generator 102.

The frequency generator 102 generates a predetermined frequency carrier wave and supplies it to the microbial cell 103. The carrier wave generated by the frequency generator 102 can be controlled within a frequency range of 8 to 1500 Hz. The frequency generator 102 can adjust the frequency of the carrier wave, thereby generating a carrier wave with an optimum frequency for the selected microbe. The determined frequency affects a fermentation rate.

The microbial cell 103 is a device in which soil microbes generates a weak electromagnetic field. The microbial cell 103 is manufactured using soil microbes having a desired effect.

When the carrier wave generated by the frequency generator 102 passes through the microbial cell 103, the biofield generated in the process of the growth of microbes is carried by the carrier wave. The biofield generated by the microbial cell 103 acts like an emitter of an amplifier transistor.

Soil microbes in the microbial cell 103 emit unique biophotons from their DNA, thereby generating a biofield having the characteristics of the microbes. When a biofield is generated within a certain space by the biofield generator 1 according to the present invention, the characteristics of the soil microbes are exhibited by the biofield. The detailed construction and manufacturing method of the microbial cell 103 will be described below.

The LED display lamp 104 flashes in accordance with operation of the frequency generator 102, thereby allowing an operator to check the operation of the frequency generator 102 by eye.

The DC output portion 105 is an output terminal of the DC module 100, thereby outputting a biofield generated using DC power.

The battery charging unit 106 is used to charge the DC battery 101.

Meanwhile, the AC module 200 generates a biofield using alternating current (AC) power. The AC module 200 includes an AC input portion 201, a fuse 202, an AC switch 203, a microbial condenser 204, and an AC output portion 205.

The AC input portion 201 is a portion electrically connected to an external AC power supply. The fuse 202 is short circuit protection fuse. The AC switch 203 is a switch for switching on and off the AC power supply.

When an Ac signal having a predetermined frequency passes through the microbial condenser 204, a biofield generated due to growth of microbes comes out of the microbial condenser 204 along with the AC signal. Therefore, the signal output from the AC output portion 205 consists of a signal having a frequency range of 50 to 60 Hz and a biofield generated by the microbial condenser 204.

The microbial condenser 204 includes two metal plates and a soil dough mixed with soil microbes provided between the two metal plates. The soil dough serves as a dielectric. The microbial condenser 204 stores electric charges, passes an alternating currents, and intercepts a direct current, thereby generating a biofield using only AC power.

The detailed construction and manufacturing method of the microbial condenser 204 will be described below.

The AC output portion 205 is an output terminal of the AC module 200 and is a biofield output terminal for outputting a biofield generated using AC power.

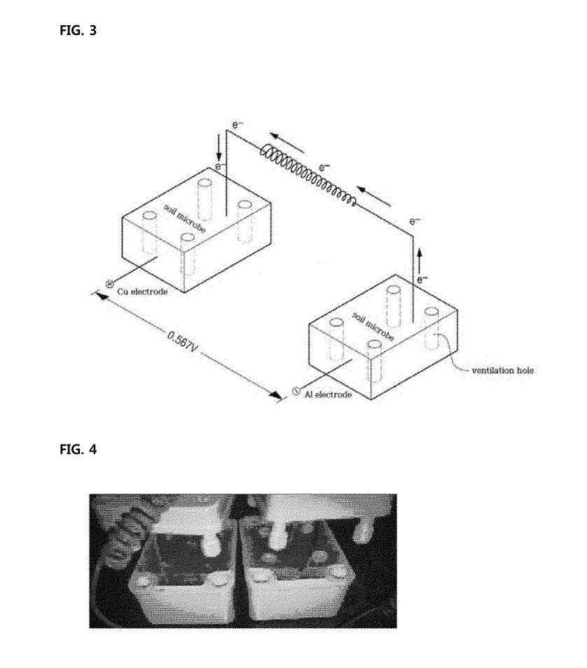

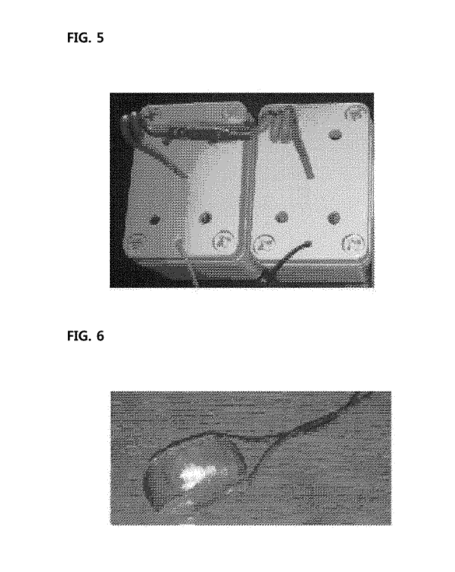

FIGS. 3 to 5 are views illustrating the construction of a microbial cell 103 according to one embodiment of the invention, in which FIG. 3 is a circuitry diagram, and FIGS. 4 and 5 are actual pictures of the microbial cell. The construction and manufacturing method of the microbial cell will be described below.

1. Preparation of Soil Dough mixed with Soil Microbes

Collected soil is sterilized at a temperature of 80 to 100° C. for three hours, and soil microbes having a desired effect are cultured. The soil and microbes are mixed with a mixing ratio of 1:5 (cultured soil microbes: soil=1:5) in terms of weight to produce a soil mixture. Then, the prepared soil mixture and salt water (for example, 3% salt water) are mixed with a mixing ratio of 4:1 (soil mixture: salt water=4:1) in terms of weight to produce soil dough.

The soil microbes having a desired effect means soil microbes that can be suitably used for treatment of food waste, preparation of fertilizer from livestock manure, promotion of plant grow, etc.

Specifically, for example, for treatment of food waste, lactobacillus that can promote lactic acid fermentation to cause fermentation rather than putrefaction is suitably selected as the soil microbe. For promotion of plant growth, photosynthetic bacteria are suitable. For preparation of fertilizer from livestock manure, an effective microorganism (EM) is a suitable microbe.

EM stands for Effective Microorganism and is a specially prepared blend of effective microorganisms that are useful for a human body and selected from a large number of kinds of microorganisms present in nature. Predominant microorganisms of the EM are yeast lactic acid bacteria and photosynthetic bacteria. Antioxidative activity attributable to a coexistence and co-prosperous relationship of these microbes is the effect of EM.

The selected soil may be soil containing a far-infrared radiation substance. For example, the soil may contain 50 to 70% of red clay, 10 of 30% of illite, 5 to 15% of barley stone, and 5 to 15% of tourmaline. Preferably, the soil may contain 60% of red clay, 20% of illite, 10% of barley stone, and 10% of tourmaline. When the soil used in the microbial cell is composed of far-infrared radiation substances, a synergy effect of the weak electromagnetic field generated from microbes and far-infrared radiation can be obtained.

2. Electrodes

Metal electrodes with different ionicities are prepared. For example, when aluminum and copper plates are prepared, the aluminum plate serves as a negative electrode and the copper plate serves as a positive electrode.

3. Vessels

Plastic vessels for containing the soil dough of item 1 and the electrodes of item 2 are prepared.

A plastic vessel for the positive electrode and a plastic vessel for the negative electrode are separately provided, and the plastic vessels are covered by respective lids provided with ventilation holes (for example, four ventilation holes).

4. Assembling a Microbial Cell

The positive electrode and the negative electrode are respectively put in the respective plastic vessels and the plastic vessels are filled with the soil dough of item 1.

Cylindrical hemp cloth bars are provided in the ventilation holes so that microbes in soil dough can perform aerobic respiration. Then the positive electrode and the negative electrode are connected to each over via a conductive wire so that electrons generated from the negative electrode can move to the positive electrode.

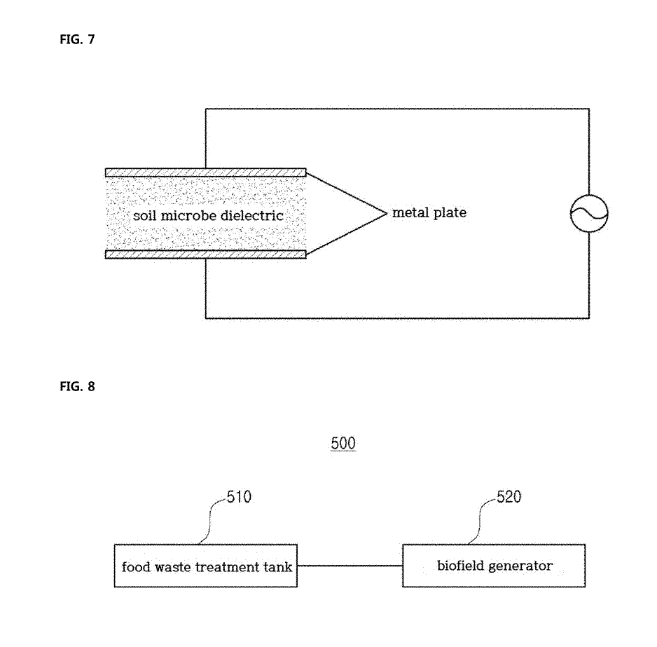

FIGS. 6 and 7 are views illustrating the construction of a microbial condenser according to one embodiment of the invention. A microbial condenser 204 is manufactured by filling a gap between two metal plates with dried soil dough mixed with soil microbes as a dielectric. The microbial condenser 204 stores electric charges. The microbial condenser 204 passes an alternating current but intercepts a direct current, thereby generating a biofield using AC power.

The composition of the soil dough mixed with soil microbes are the same as that used in the microbial cell 103. However, there is a difference that the soil dough used in the microbial condenser 204 is dried to have a water content of 10% or less.

The biofield generator using soil microbes, having the structure described above, generates a biofield when it is applied to a certain device, for example, a food waste treatment device, a livestock manure composing device, a food storage device, a plant growth promoting device, etc., thereby exhibiting the characteristics of the soil microbes provided therein.

FIG. 8 is a view illustrating an application example of the biofield generator using soil microbes, according to one embodiment of the present invention. According to the application example, the biofield generator is applied to a food waste treatment device and causes fermentation of food waste.

With reference to FIG. 8, according to one embodiment of the present invention, a food waste fermentation device 500 includes a food waste treatment tank 510 for containing food waste and a first biofield generator 520 electrically connected to the food waste treatment tank 510.

The first biofield generator 520 is installed in the food waste treatment tank 510, or an output terminal of the first biofield generator 520 is electrically connected to the food waste treatment tank 510.

The food waste treatment tank 510 is mostly made of reinforced ferroconcrete. Since steel bars have a high electrical conductivity, free electrons that carry the biofield can easily flow. Since steel frames are connected to each other in the ferroconcrete, when the output terminal of the first biofield generator 520 is electrically connected to the ferroconcrete, the entire food waste treatment tank 510 is filled with the biofield.

The biofield has quantum nature. Therefore, the biofield can easily pass through a concrete wall and the effect of the biofield can be easily applied to the food waste. The quantum energy field having activity information of lactic acid bacteria functions to ferment food waste contained in the food waste treatment tank 510.

The reason why the biofield has quantum nature is that the biofield is an energy field generated due to biophotons of DNA.

When food waste is decomposed, carbohydrates, protein, and fat are decomposed to produce ammonia, methylmercaptan, hydrogen sulfide, trimethylamine, etc. which are sources of odor. However, when the biofield generator 520 is applied to a food waste decomposition process, lactic acid fermentation of food waste in the food waste treatment tank 510 is activated and promoted. Therefore, the food waste undergoes fermentation rather than putrefaction, resulting in reduction in odor.

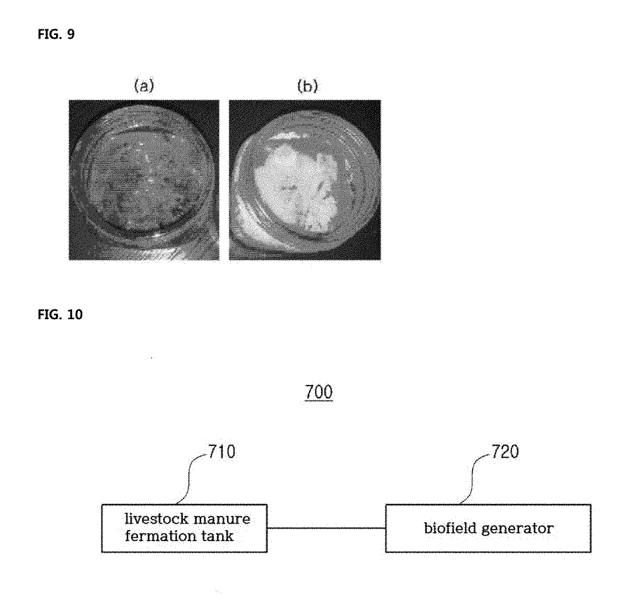

FIG. 9 is pictures illustrating food decomposition results before and after application of a biofield. A mixture of water and food waste treated with a biofield and a mixture of water and food waste untreated with a biofield were put in respective jars and changes in the jars were observed for three months.

FIG. 9(a) illustrates a sample that is untreated with a biofield. As shown in FIG. 9(a), black putrefaction occurs with bad odor. FIG. 9(b) is a sample treated with a biofield. As shown in FIG. 9(b), lactic acid fermentation occurs with a white scum and smell of liquor. This is interpreted as the effect of lactobacillus of the soil microbe used in the microbial cell.

FIG. 10 is another application example of the biofield generator 1 using soil microbes. The biofield generator 1 is applied to a livestock manure composing device, thereby reducing odor occurring in the process of composing livestock manure and improving compost maturity.

With reference to FIG. 10, according to one embodiment, a livestock manure composting device 700 includes a livestock manure fermentation tank 710 for containing livestock manure, and a second biofield generator electrically connected to the livestock manure fermentation tank 710. The second biofield generator 720 is installed in the livestock manure fermentation tank 710 or an output terminal of the second biofield generator 720 is electrically connected to the livestock manure fermentation tank 710.

The livestock manure fermentation tank 710 is mostly made of ferroconcrete. Since steel bars have a high electrical conductivity, electrons that carry a biofield can easily flow through the steel bars. Since the steel frames are connected to each other in the entire concrete structure, when the output terminal of the second biofield generator 720 and the ferroconcrete structure are electrically connected, the livestock manure fermentation tank 710 is filled with the biofield.

That is, when the second biofield generator 720 is electrically connected to the livestock manure fermentation tank 710 such that a biofield is formed in the livestock manure fermentation tank 710, the biofield performs a catalytic action in a urea production reaction of ammonia generated from livestock manure stored in the livestock manure fermentation tank 710, thereby reducing odor and improving a fertilizer effect.

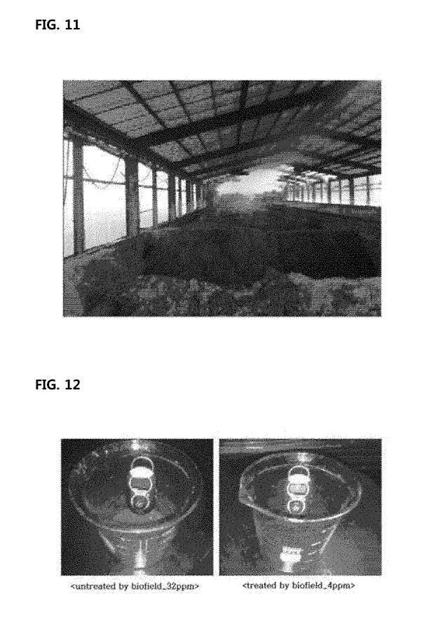

FIG. 11 is an actual picture of a livestock manure mixing tank (fermentation tank) in which the biofield generator according to the invention is installed. FIG. 12 is a view illustrating the results of a compost maturity test. With reference to FIG. 9, livestock manure fertilizer produced from a plant to which the biofield is not applied exhibits an ammonia concentration of 32 ppm, but livestock manure fertilizer produced from a plant in which the biofield generator is installed and to which the biofield is applied for one month exhibits an ammonia concentration of 4 ppm. This means that a problem of odor is solved, and a fertilizer production rate is increased two times. In addition, 800,000 bags of livestock manure fertilizer were supplied to farms per year. As a result, a germination percentage of cultivation crops was increased, and also increases in the yields of pepper, tomatoes, deodeok, cabbage, corn, etc. were verified.

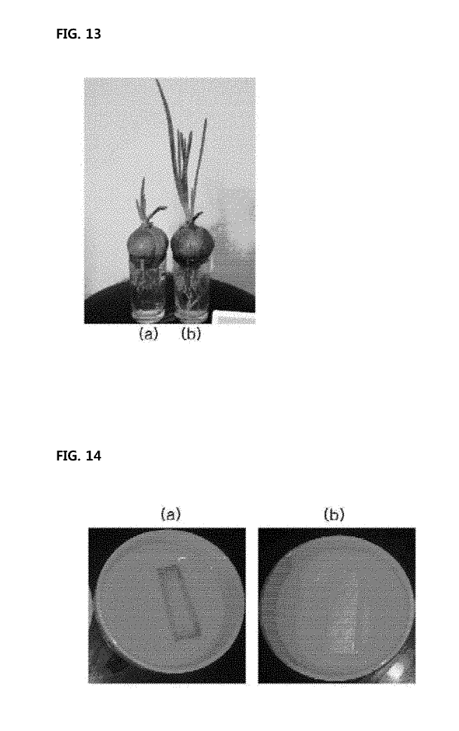

FIGS. 13 and 14 are test results of samples to which the biofield generator according to one embodiment of the invention is applied or not applied.

FIG. 13 illustrates a water culture result of onions that were cultured for one week. The onion (b) in FIG. 13 is cultured with water treated with a biofield and to the onion (a) in FIG. 13 is cultured with water untreated with a biofield. The result shows the onion 13(b) grows two times faster than the onion 13(a). This is considered due to a photosynthesis promoting effect of photosynthetic bacteria of soil microbes used in the biofield generator.

FIGS. 14 illustrates two lumps of tofu in which one was treated with a biofield and the other was not treated with a biofield. FIG. 14(b) shows the tofu that was stored in a food storage device (refrigerator) equipped with the biofield generator for 30 days, and FIG. 14(a) shows the tofu that was stored in a normal refrigerator that is not equipped with the biofield generator for 30 days.

As illustrated in FIG. 14, the tofu (see FIG. 14(b)) treated with the biofield was still fresh even after 30 days of storage, but the tofu (see FIG. 14(a)) untreated with the biofield severely decayed.

Although specific embodiments have been described with reference to the accompanying drawings in the present disclosure, the present invention is not limited to the presented embodiments, and those skilled in the art will appreciate that various modifications, alterations, changes, additions, and substitutions are possible, without departing from the scope and spirit of the invention as disclosed in the accompanying claims. For example, a biofield generator using soil microbes according to the present invention can be applied to an organic waste composing process for composing organic waste such as agro-fishery byproducts, slaughter plant byproducts, and food plant byproducts as well as to a food waste fermentation device and a livestock manure composing device.

Accordingly, the scope of the present invention should not be limited to the embodiments described above but be construed to include not only the appended claims but also equivalents thereof.

### INDUSTRIAL APPLICABILITY

According to the food waste fermentation device according to the present invention, it is possible to solve a problem of odor by promoting lactic acid fermentation of food waste rather than putrefaction of food waste.

In addition, according to the livestock manure composing device according to the present invention, it is possible to reduce odor of livestock manure and improve a fertilizer effect because a biofield performs a catalytic action in a urea production reaction of ammonia generated from livestock manure.

1. A food waste fermentation device using soil microbes, the food waste fermentation device comprising:
a food waste treatment tank for containing food waste; and
a biofield generator electrically connected to the food waste treatment tank and promoting lactic acid fermentation of the food waste, the biofield generator comprising either a DC module or an AC module,
the DC module comprising a DC battery, a frequency generator receiving DC power from the DC battery and generating a predetermined frequency carrier wave, and a microbial cell and a DC output portion electrically connected to the frequency generator, the DC module generating a biofield consisting of an electromagnetic field generated by the frequency generator and an electromagnetic field generated by the microbial cell;
the AC module comprising an AC input portion, a microbial condenser electrically connected to the AC input portion, and an AC output portion electrically connected to the microbial condenser, the AC module generating a biofield consisting of an electromagnetic field generated using an AC input signal and an electromagnetic field generated by the microbial condenser.

2. The food waste fermentation device according to claim 1, wherein the biofield generator further comprises an LED display lamp electrically connected between the frequency generator and the DC output portion and flashing in accordance with operation of the frequency generator.

3. The food waste fermentation device according to claim 1, wherein the microbial cell comprises:
two plastic vessels for containing soil dough mixed with soil microbes including lactobacillus to cause lactic acid fermentation of food waste;
a negative electrode and a positive electrode respectively installed in the soil dough in the two plastic vessels;
a conductive wire connecting the two plastic vessels to each other such that electrons generated from the negative electrode move to the positive electrode; and
ventilation holes provided to the two plastic vessels such that the soil microbes in the soil dough perform aerobic respiration.

4. The food waste fermentation device according to claim 1, wherein the soil dough is prepared by mixing a soil mixture and salt water with a mixing ratio of 4:1 in terms of weight, the soil mixture being prepared by mixing sterilized soil and cultured soil microbes including lactobacillus with a mixing ratio of 5:1 in terms of weight.

5. The food waste fermentation device according to claim 4, wherein the sterilized soil contains a far-infrared radiation substance.

6. The food waste fermentation device according to claim 1, wherein the microbial condenser uses dried soil dough mixed with soil microbes, provided between two metal plates, as a dielectric.

7. The food waste fermentation device according to claim 6, wherein the soil dough is prepared by mixing a soil mixture and salt water with a mixing ratio of 4:1 in terms of weight, the soil mixture being prepared by mixing sterilized soil and cultured soil microbes including lactobacillus with a mixing ratio of 5:1 in terms of weight.

8. The food waste fermentation device according to claim 7, wherein the sterilized soil contains a far-infrared radiation substance.

9. A livestock manure composting device using soil microbes for preparing fertilizer using livestock manure, the livestock manure composing device comprising:
a livestock manure fermentation tank for containing livestock manure and fermenting the livestock manure; and
a biofield generator electrically connected to the livestock manure fermentation tank and promoting a urea production reaction of ammonia generated from the livestock manure, the biofield generator comprising a DC module or an AC module,
the DC module comprising a DC battery, a frequency generator receiving DC power and generating a predetermined frequency carrier wave, and a microbial cell and a DC output portion electrically connected to the frequency generator, the DC module generating a biofield consisting of an electromagnetic field generated by the frequency generator and an electromagnetic field generated by the microbial cell,
the AC module comprising an AC input portion, a microbial condenser electrically connected to the AC input portion, and an AC output portion electrically connected to the microbial condenser, the AC module generating a biofield consisting of an electromagnetic field generated using an AC input signal and an electromagnetic field generated by the microbial condenser.

10. The livestock manure composing device according to claim 9, wherein the microbial cell comprises:
two plastic vessels for containing soil dough mixed with soil microbes including an effective microorganism to perform a urea production reaction of livestock manure;
a negative electrode and a positive electrode installed in the soil dough contained in the two plastic vessels;
a conductive wire connecting the two plastic vessels to each other such that electrons generated from the negative electrode move to the positive electrode; and
ventilation holes provided to the two plastic vessels such that the soil microbes in the soil dough in the two plastic vessels perform aerobic respiration.

11. The livestock manure composing device according to claim 10, wherein the soil dough is prepared by mixing a soil mixture and salt water with a mixing ratio of 4:1 in terms of weight, the soil mixture being prepared by mixing sterilized soil and soil microbes including an effective microorganism with a mixing ratio of 5:1 in terms of weight.

12. The livestock manure composing device according to claim 11, wherein the sterilized soil contains a far-infrared radiation substance.

13. The livestock manure composing device according to claim 9, wherein the microbial condenser uses dried soil dough mixed with soil microbes, provided between two metal plates, as a dielectric.

14. The livestock manure composing device according to claim 13, wherein the soil dough is prepared by mixing a soil mixture and salt water with a mixing ratio of 4:1 in terms of weight and is dried to have a water content of 10% or less, the soil mixture being prepared by mixing sterilized soil and cultured soil microbes including an effective microorganism with a mixing ratio of 5:1 in terms of weight.

15. The livestock manure composing device according to claim 14, wherein the sterilized soil contains a far-infrared radiation substance.

16. A biofield generator generating a biofield, the generator comprising:
a frequency generator generating a predetermined frequency carrier wave; and
a microbial cell electrically connected to the frequency generator,
wherein an output terminal of the microbial cell outputs a biofield consisting of an electromagnetic field generated by the frequency generator and an electromagnetic field generated by the microbial cell.

17. The biofield generator according to claim 16, wherein the microbial cell comprises:
two plastic vessels for containing soil dough mixed with soil microbes;
a negative electrode and a positive electrode installed in the soil dough in the two plastic vessels;
a conductive wire connecting the two plastic vessels to each other such that electrons generated from the negative electrode move to the positive electrode; and
ventilation holes provided to the two plastic vessels such that the soil microbes in the soil dough perform aerobic respiration.

18. The biofield generator according to claim 17, wherein the soil dough is prepared by mixing a soil mixture and 3% salt water with a mixing ratio of 4:1 in terms of weight, the soil mixture being prepared by mixing soil sterilized at a temperature of 80 to 100° C. for three hours and cultured soil microbes with a mixing ratio of 5:1 in terms of weight.

19. The biofield generator according to claim 18, wherein the sterilized soil contains a far-infrared radiation substance.

20. The biofield generator according to claim 16, further comprising an LED display lamp electrically connected to the frequency generator and flashing in accordance with operation of the frequency generator.

21. A biofield generator generating a biofield, the biofield generator comprising:
an AC input portion;
a microbial condenser electrically connected to the AC input portion and using dried soil dough mixed with soil microbes, provided between two metal plates, as a dielectric,
when an AC input signal supplied through the AC input portion is applied between the metal plates, the biofield generator generates a biofield consisting of an electromagnetic field generated using the AC input signal applied between the metal plates and an electromagnetic field generated by the microbial condenser.

22. The biofield generator according to claim 21, wherein the soil dough is prepared by mixing a soil mixture and 3% salt water with a mixing ratio of 4:1 in terms of weight and dried to have a water content of 10% or less, the soil mixture being prepared by mixing soil sterilized at a temperature of 80 to 100° C. for three hours and cultured soil microbes with a mixing ratio of 5:1 in terms of weight.

23. The biofield generator according to claim 22, wherein the sterilized soil contains a far-infrared radiation substance.

24. A microbial cell comprising:
two plastic vessels for containing soil dough mixed with soil microbes;
a negative electrode and a positive electrode respectively installed in the soil dough in the two plastic vessels;
a conductive wire connecting the two plastic vessels to each other such that electrons generated from the negative electrode move to the positive electrode; and
ventilation holes provided to the two plastic vessels such that the soil microbes in the soil dough in the two plastic vessels perform aerobic respiration.

25. The microbial cell according to claim 24, wherein the soil dough is prepared by mixing a soil mixture and 3% salt water with a mixing ratio of 4:1 in terms f weight, the soil mixture being prepared by mixing soil sterilized at a temperature of 80 to 100° C. for three hours and cultured soil microbes with a mixing ratio of 5:1 in terms of weight.

26. The microbial cell according to claim 25, wherein the sterilized soil contains a far-infrared radiation substance.

27. A microbial condenser having a dielectric provided between two metal plates, wherein the dielectric is made of dried soil dough mixed with soil microbes, and wherein a biofield generated by the soil microbes between the two metal plates is output from the microbial condenser.

28. The microbial condenser according to claim 27, wherein the soil dough is prepared by mixing a soil mixture and 3% salt water with a mixing ratio of 4:1 in terms of weight and dried to have a water content of 10% or less, the soil mixture being prepared by mixing soil sterilized at a temperature of 80 to 100° C. for three hours and cultured soil microbes with a mixing ratio of 5:1 in terms of weight.
